(19) United States
(12) Patent Application Publication
(10) Pub. No.: US 2024/0241902 A1
(43) Pub. Date: Jul. 18, 2024

(54) NLP-BASED RECOMMENDER SYSTEM FOR EFFICIENT ANALYSIS OF TROUBLE TICKETS

(71) Applicant: Telefonaktiebolaget LM Ericsson (publ), Stockholm (SE)

(72) Inventors: Serveh Shalmashi, Enebyberg (SE); Forough Yaghoubi, Täby (SE); Leif Jonsson, Hässelby Villastad (SE); Nuria Marzo I Grimalt, London (GB); Amir H. Payberah, Stockholm (SE)

(21) Appl. No.: 18/563,413

(22) PCT Filed: Jun. 3, 2022
(86) PCT No.: PCT/EP2022/065175

§ 371 Date: Nov. 22, 2023

Related U.S. Application Data
(60) Provisional application No. 63/196,488, filed on Jun. 3, 2021.

(51) Int. Cl. G06F 16/383; G06F 16/33; G06F 40/284

(52) U.S. Cl. CPC G06F 16/383; G06F 16/3344; G06F 40/284

(57) ABSTRACT

Systems and methods are disclosed herein efficient analysis of a (new) trouble report (TR) and providing a list of candidate answers. In one embodiment, a method performed by a computing device comprises obtaining a query from a trouble report, the query comprising text. The method further comprises pre-processing the query to provide a pre-processed query and applying the pre-processed query to a first representation-based model to provide a representation of the pre-processed query. The method further comprises computing similarity metrics between the representation of the pre-processed query and representations of pre-processed answers of existing, previously processed, trouble reports and creating an initial list of candidate answers based on the similarity metrics. The initial list of candidate answers comprises candidate answers selected from among answers of the existing trouble reports based on the similarity metrics.

### RELATED APPLICATIONS

This application claims the benefit of provisional patent application Ser. No. 63/196,488, filed Jun. 3, 2021, the disclosure of which is hereby incorporated herein by reference in its entirety.

### TECHNICAL FIELD

The present disclosure relates to machine learning (ML) and, more specifically, a ML procedure for automated recommendation of solutions for a Trouble Report (TR) that includes domain-specific and/or company-specific text.

### BACKGROUND

A current trend in the telecom industry, and in technology industries in general, is working towards automating time consuming tasks that have previously been carried out manually. One such task is the handling of different types of problems that occur in the complex software and hardware infrastructure in modern telecommunication systems. To avoid having these problems lead to service down time or other forms of harm to the customer experience, they must be quickly detected, identified, and resolved, which is often done by engineers in Network Operation Centers (NOCs). When the engineers observe a problem related to the hardware or software of the running system that they cannot solve on site, they create a Trouble Report (TR) (also called trouble ticket or, commonly, Bug Report) to track information regarding the detection, characteristics, and hopefully an eventual resolution (also referred to herein as an “answer”) of the problem. According to [1], fault localization “is widely recognized to be one of the most tedious, time consuming, and expensive yet equally critical activities in program debugging”.

TR routing and analysis is a labor-intensive process in which engineers analyze characteristics of the problems to find possible solutions, and it opens up the question of whether TR routing and analysis can be effectively automated. The complexity of the problem and the type of data makes it hard to automate using any hard-coded rules. With today's huge development in the field of ML, specifically in Natural Language Processing (NLP), it is possible to benefit from historical data by analyzing previous trouble tickets using ML and infer a solution to a new problem from them. The aim is finding a resolution to a TR ticket in an automated way thus substantially shortening the lead time to solve TRs. In [2], it is shown how one can use Machine Learning (ML) to automatically route a TR to the correct design team. However, there is a need for an effective solution to automate the analysis phase, and in particular, the identification of the solution or answer to an observed problem.

### SUMMARY

Systems and methods are disclosed herein for efficient analysis of a (new) trouble report (TR) and providing a list of relevant candidate answers. In one embodiment, a method performed by a computing device comprises obtaining a query from a trouble report, the query comprising text. The method further comprises pre-processing the query to provide a pre-processed query and applying the pre-processed query to a first representation-based model to provide a representation (e.g., a dense vector representation) of the pre-processed query. The pre-processing of the query is such that the query is formatted in a way that is acceptable to the first representation-based model. The method further comprises computing similarity metrics between the representation of the pre-processed query and a plurality of representations of a plurality of pre-processed answers of a plurality of existing, previously processed, trouble reports. The method further comprises creating an initial list of candidate answers based on the similarity metrics, the initial list of candidate answers comprising a plurality of candidate answers selected from among a plurality of answers of the plurality of existing trouble reports based on the similarity metrics. In this manner, the initial list of candidate answers can be provided in an efficient manner.

In one embodiment, the first representation-based model is a model that is able to create a semantic representation of a sentence that captures its meaning in a dense vector. In one embodiment, the first representation-based model is model that uses an attention mechanism for understanding and encoding sentences as a whole. In one embodiment, the first representation-based model is a bi-directional model (i.e., considers words left-to-right and right-to-left) that looks at all words in a sentence to encode the sentence.

In one embodiment, the first representation-based model is a first representation-based Bidirectional Encoder Representation from Transformer (BERT) model. In another embodiment, the first representation-based model is a first sentence-BERT model, a first Expansion via Prediction of Importance with Contextualization (EPIC) model, a first Representation-focused BERT (RepBERT) model, a first Approximate nearest neighbor Negative Contrastive Learning (ANCE) model, or a first Contextualized Late interaction over BERT (ColBERT) model.

In one embodiment, the method further comprises pre-processing a plurality of answers of the plurality of existing trouble reports to provide the plurality of pre-processed answers and applying the plurality of pre-processed answers to a second representation-based model to provide the plurality of representations of the plurality of pre-processed answers. In one embodiment, pre-processing the plurality of answers and applying the plurality of pre-processed answers to the second representation-based model are performed prior to obtaining the query, and the method further comprises storing the plurality of representations of the plurality of pre-processed answers. In one embodiment, the first representation-based model and the second representation-based model are the same representation-based BERT model. In another embodiment, the first representation-based model and the second representation-based model are the same sentence-BERT model, the same EPIC model, the same RepBERT model, the same ANCE model, or the same ColBERT model.

In one embodiment, the first and second representation-based models are same model, the same model being a model that is able to create a semantic representation of a sentence that captures its meaning in a dense vector. In one embodiment, the first and second representation-based models are same model, the same model being a model that uses an attention mechanism for understanding and encoding sentences as a whole. In one embodiment, the first and second representation-based models are same model, the same model being a bi-directional model (i.e., considers words left-to-right and right-to-left) that looks at all words in a sentence to encode the sentence.

In one embodiment, the method further comprises performing a re-ranking scheme that selects a subset of the plurality of candidate answers comprised in the initial list of candidate answers to provide a ranked list of candidate answers. In one embodiment, performing the re-ranking scheme comprises applying the pre-processed query and the initial list of candidate answers to a BERT-based re-ranker model to provide the ranked list of candidate answers. In one embodiment, the BERT-based re-ranker model is a monoBERT model, a duoBERT model, or a Contextualized Embeddings for Document Ranking (CEDR) model. In one embodiment, the BERT-based re-ranker model comprises an ensemble of BERT-based models.

In one embodiment, pre-processing the query comprises: (a) tokening text comprised in the query, (b) detecting abbreviations in the text comprised in the query and replacing the detected abbreviations with complete words, (c) removing numerical data, (d) handling one or more special tokens, or (e) a combination of any two or more of (a)-(d).

In one embodiment, the query comprises text from an observation of the trouble report. In one embodiment, the query further comprises text from a header of the trouble report.

In one embodiment, obtaining the query comprises determining a faulty area based on information about a product involved in the trouble report and including the faulty area within the query.

In one embodiment, the similarity metrics are cosine similarity metrics, inner product metrics, or Euclidean distance metrics.

Corresponding embodiments of a computing device are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a process for handling Trouble Reports (TRs) in a large organization;

FIG. 2 illustrates a text ranking problem;

FIG. 3 is a summary of existing solutions for the text ranking problem;

FIG. 4 illustrates problems with existing solutions for the text ranking problem;

FIG. 5 illustrates multi-stage text ranking;

FIG. 6 illustrates an example solution space for the present disclosure;

FIG. 7 is a block diagram that represents one embodiment of a text ranking procedure disclosed herein;

FIG. 8 illustrates one example of possible inputs to the text ranking procedure of FIG. 7;

FIG. 9 illustrate an example of faulty area mapping in accordance with an embodiment of the present disclosure;

FIG. 10 is a block diagram that illustrates one example embodiment of the pre-processing stage of the text ranking procedure of FIG. 7;

FIG. 11 is a block diagram that illustrates one example embodiment of the initial retrieval stage of the text ranking procedure of FIG. 7;

FIG. 12 illustrates a sentence-BERT model that can be used in the initial retrieval stage of FIG. 11 in accordance with one example embodiment of the present disclosure;

FIG. 13 is a block diagram that illustrates one example embodiment of the re-ranker stage of the text ranking procedure of FIG. 7;

FIG. 14 is a block diagram that illustrates another example embodiment of the re-ranker stage of the text ranking procedure of FIG. 7;

FIG. 15 illustrates a monoBERT model that can be used in the re-ranker stage of FIG. 13 (or FIG. 14) in accordance with one example embodiment of the present disclosure;

FIG. 16 is a flow chart that illustrates a computer-implemented text ranking procedure in accordance with embodiments of the present disclosure;

FIG. 17 is a schematic block diagram of a computing device according to some embodiments of the present disclosure;

FIG. 18 is a schematic block diagram that illustrates a virtualized embodiment of the computing device of FIG. 17 according to some embodiments of the present disclosure; and

FIG. 19 is a schematic block diagram of the computing device of FIG. 17 according to some other embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Some terms used in the present disclosure are as follows:
BERT model: Bidirectional Encoder Representation from Transformer (BERT). It is a model that receives a sentence and outputs contextual embeddings. It can be used inside different other models.
BERT-based models: Models that inside its structure have a BERT model. For example, Sentence-BERT has a BERT model inside, monoBERT has a BERT model inside as well.
Sentence-BERT: Model composed by a BERT-model and a Pooling Layer. It creates a representation of a sentence.
monoBERT: Model composed by a BERT-model and a linear layer. It gives a ranking score to a query and an answer that are input to the model.
Representation-based architecture: This is a type of architecture that creates a representation of a sentence. The representations of sentences can be compared using a similarity measure. They are very fast architectures.
Similarity Measure or Metric: A measure or metric that indicates the degree or amount of similarity between are two vectors or two matrices. The similarity measure or metric may be, e.g., cosine similarity, inner product, Euclidean distance (for vector representations).

Embodiments of the present disclosure use models like Sentence-BERT and monoBERT, which are BERT-based model (i.e., have BERT models inside). BERT provides high accuracy because it is an attention-based mechanism. As such, other non-BERT models that provide similarly high accuracy (e.g., due to being an attention-based mechanism) can alternatively be used.

Some type of BERT-based models can be substituted by others. For example:
Sentence-BERT: Sentence-BERT can be substituted by Expansion via Prediction of Importance with Contextualization (EPIC) [20], Representation-focused BERT (RepBERT) [21], Approximate nearest neighbor Negative Contrastive Learning (ANCE) [22], Contextualized Late interaction over BERT (ColBERT) [23].
BERT model (what is inside sentence-BERT and mono-BERT): A BERT model can be substituted by Robustly Optimized BERT pretraining approach (ROBERTa) [24], Distilled version of BERT (DistilBERT) [25], Efficiently Learning an Encoder that Classifies Token Replacements Accurately (ELECTRA) [26], XLNet [27].
monoBERT: duoBERT [11], Contextualized Embeddings for Document Ranking (CEDR) [29], mono-T5 [28].

It should also be noted that while the discussion herein focuses on BERT-based models, the solution(s) described herein are not limited to BERT-based models. Other types of models have similar or better accuracy than BERT-based models that have the same or similar technical features may alternatively be used. For example, in one embodiment, the representation-based model used herein for the initial retrieval stage and/or the model(s) used herein for the re-ranking stage may be any model that has one or more of the following technical features: it is able to create a semantic representation of a sentence that captures its meaning in a dense vector, it uses an attention mechanism for understanding and encoding sentences as a whole, and/or it is a bi-directional model (i.e., considers words left-to-right and right-to-left) that looks at all words in a sentence to encode the sentence. The model(s) used for the initial retrieval stage preferably also have an architecture that enables separate processing of the new query and past answers, as described below.

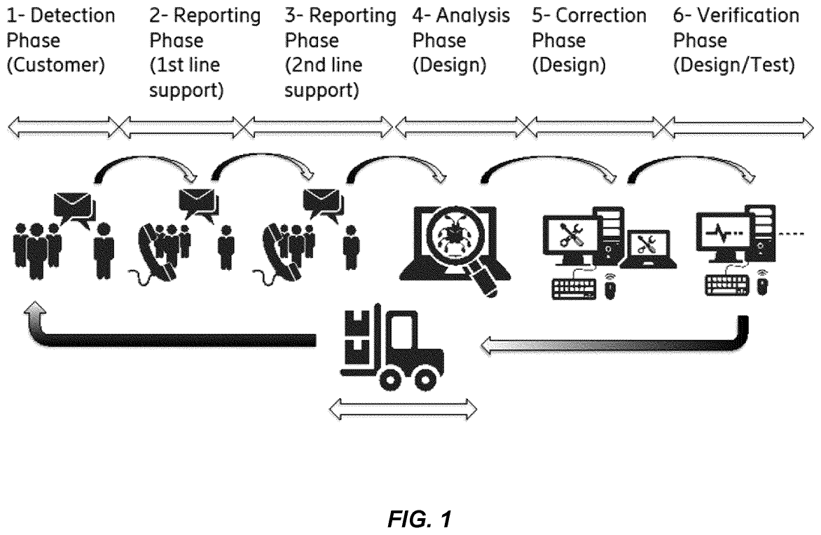

There currently exist certain challenge(s). As discussed above, Trouble Report (TR) routing and analysis is a labor-intensive process in which engineers analyze characteristics of the problems to find possible solutions. Thus, there is a desire to automate this process. In this regard, FIG. 1 shows the six steps and the complexity of the process of troubleshooting. It starts by detecting a problem in step 1. The detected problem may be, for example, a crash in the network. Then, the observations of the problem are reported in a TR in steps 2 and 3. This TR will be analyzed and corrected in steps 4 and 5 by engineers that will verify the solution in step 6. As previously stated, this is a time-consuming process, and it requires many steps even to solve minor faults. In [2], it is shown how one can use Machine Learning (ML) to automatically route a TR to the correct design team.

Systems and methods are disclosed herein that relate to automation of step 4 (i.e., the analysis phase) to provide a solution (also referred to herein as an “answer”) that can be used in step 5 (i.e., the correction phase), where these steps are typically the most time-consuming steps of the troubleshooting processing. This automation is via use of ML and Natural Language Processing (NLP) techniques. In this regard, it should be noted that the data related to these tasks is often unstructured text with many abbreviations, numbers, Internet Protocol (IP) addresses, lots of code/command lines, and some tables. Even processing and cleaning such a data is not easy.

In the embodiments of the solution described herein, state-of-the-art ML techniques, specifically text ranking techniques, are applied to the problem of fault analysis. Below is a summary of the existing techniques in the area of text ranking.

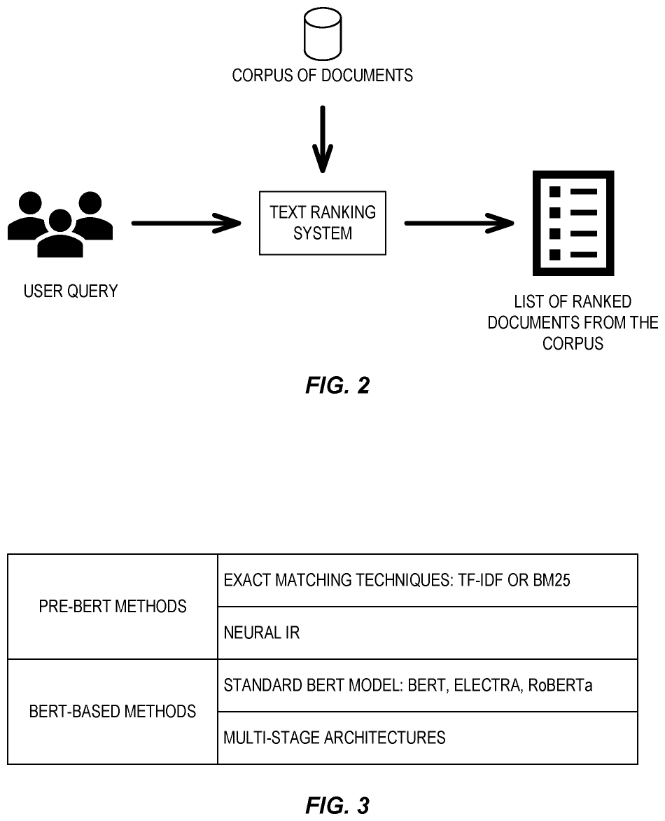

The text ranking problem is always composed of two inputs, a ranking system, and an output, as shown in FIG. 2. The system has two inputs: the user query, which is natural language text where users express the information they want to find, and the corpus of documents, which is the data to be searched. The output of the system is a list of ranked documents from the corpus. The list is sorted from the most relevant document to the least relevant document, with respect to the user query. The text ranking system is where the query and the corpus of documents are analyzed in order to produce the best possible rankings.

As described below, in embodiments of the present disclosure, a text description of a fault detected (the observation text) is used as, or as part of, the user query and past solutions (the answer text of historical TRs) that were provided for given faults are used as the corpus of documents. The best possible past solutions with respect to the description of a problem are thus identified and ranked.

There are many existing solutions available in the area of Information Retrieval (IR) related to the Text Ranking problem. Herein, these existing solutions are divided to two classes, namely, pre-BERT methods and BERT-based methods. Bidirectional Encoder Representation from Transformers (BERT) [3] is a deep learning model that revolutionized the field of NLP in 2019 in terms of performance. Different existing solutions are listed in FIG. 3.

Some example motivating factors for an automated procedure for identifying potential solutions to a problem specified in a TR are as follows:
Fault handling is an expensive and labor-intensive task.
There is a lack of supporting tools in the area of automatic fault localization, bug assignment, and bug analysis, in the context of large-scale industrial system development.
From a customer relations perspective, it is often crucial to quickly understand the cause of a bug and any further possible (adverse) manifestations of the bug beyond what has already been observed. Once this is understood, there might be possible workarounds to mitigate the problems caused by the bug. It is not always necessarily crucial to actually correct the fault very quickly, but the customer wants to understand the problem and its implications quickly. Speed in the fault localization process leads to better customer relations for any company. With this proposal, it is possible to quickly find a possible answer to a TR, and rapidly get back to the customer with an explanation of the problem.
There is a need to minimize waste in the fault handling process. Waste consists of humans performing repetitive, mundane, error-prone, and laborious tasks. The more that the fault handling process can be automated, the more efficient and less wasteful it becomes.

One of the major problems with classical retrieval methods is that they require a high degree of matching of the text between the query (a new TR) and target (historical match candidates). This is mitigated by embodiments of the present disclosure, since embodiments of the present disclosure bridge this semantic gap between the observation and answer text.

As mentioned above, there are many solutions on IR related to the text ranking tasks. However, there is still much room for improvement in the effectiveness of these techniques for more complex and domain-specific retrieval tasks such as the troubleshooting report.

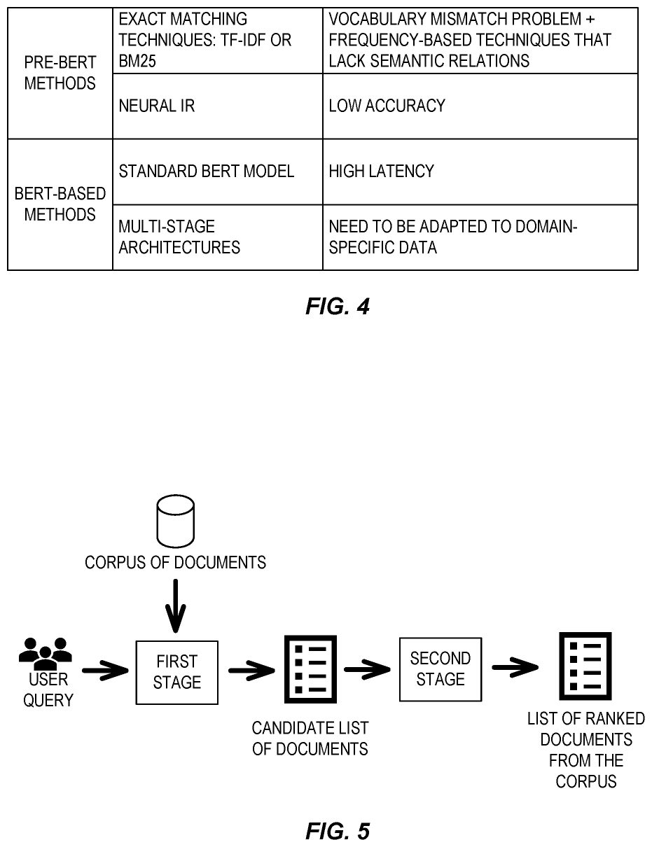

Among the existing solutions, the pre-BERT methods lack accuracy when compared to BERT-based methods. Especially, exact matching techniques that are frequency-based lack the sematic relation between words needed to bridge sematic concepts. They rely on hand-crafted features which are time-consuming in design process as opposed to neural IR [4]. Neural IR models with sufficient model capacity have more potential for learning such complicated tasks than traditional shallow models, but they still are not as effective as BERT-based methods, as they lack the bi-directionality that BERT methods have and can only look at sentences left-to-right or right-to-left and don't capture well long term dependencies. However, the performance of BERT-based methods [5] often comes at the price of high latency and computational complexity. FIG. 4 shows some of the most important problems with existing solutions.

In the telecommunication domain and specifically with trouble shooting data, one of the main problems with BERT-based methods is that their solution cannot be used directly, as some level of mapping of domain specific data is needed. Even though the availability of pretrained large text NLP models, such as Google's BERT [3], OpenAI's GPT-3 [6], and XLNet [7], made a big impact in the area of IR, these models are trained on large, diverse training sets. They are useful for modeling high frequency textual features common across various corpuses such as Wikipedia. However, the same models perform poorly when applied on highly specialized corpuses with highly informative yet infrequent tokens such as in specialized trouble report tasks.

Furthermore, the latency of executing a model in an industry application is very important. However, the focus of BERT-based solutions is more on accuracy, which is very important, but they neglect the latency of the whole process [5].

Multi-stage solutions shown in FIG. 5 are a promising solution. A detailed review of multi-stage solutions exists in [5]. In such a solution, there is a first stage that analyzes the query and the whole corpus of documents to generate a candidate list of documents of size K, which is then sent to the second stage. The second stage only focuses on ranking the candidate list of documents, which is a much shorter list than a list containing the whole corpus. FIG. 5 exemplifies the multi-stage architectures for text ranking.

Even though multi-stage ranking is used often in literature, it mostly uses simple, light models such as BM-25 for the first stage with high recall where they pass 100-1000 documents to the second stage. Then, the second stage uses highly computationally intensive models such as BERT. However, this method is potentially inefficient when the performance of the first stage is in a low plateau in terms of accuracy. The performance of the second stage is limited to the performance of the first stage.

Embodiments of a multi-stage BERT-based architecture that address the tradeoff between increased performance and computational cost are disclosed herein.

Note that, efficiency and scalability of new state-of-the-art ranking algorithms is still an underexposed research area that is likely to become more important in the near future as available data sets are rapidly increasing in size.

The problem of creating a recommender system for trouble tickets has been tackled by the authors in [8]. They proposed a method for automatically resolving trouble tickets with a hybrid NLP model. Their solution is an ensemble of pre-BERT like Long Short Term Memory (LSTM) and Latent Dirichlet Allocation (LDA) where the results from each individual model were handled with a stacked ensemble layer, which is another neural network. The data used in the evaluation process was much simpler and shorter than TRs targeted by the embodiments described herein. In addition, the authors in [8] did not consider the latency of the process as part of their performance metric. Ensemble of pre-BERT techniques is discussed in paper [9] as well; however, in the approach described in this paper, the authors formulated the problem as a non-convex optimization problem which was solved with a heuristic solution for a simplified scenario with focus on accuracy. Consequently, their approach leads to a sub-optimal result.

Certain aspects of the present disclosure and their embodiments may provide solutions to the aforementioned or other challenges. Systems and methods are disclosed herein for retrieving a list of candidate answers to a Trouble Report (TR) (e.g., a telecom domain TR) from its observation text. Note that the example embodiments described herein are oftentimes described as being specific to the telecom domain, but the solution is general and can be adapted to other domains. Embodiments of the present disclosure include new learning components for TR ranking which achieves high accuracy while keeping the computational complexity low and minimizing the processing time in the design process.

In general, given a new observation of a fault, data from past trouble reports is processed in order to retrieve a list of candidate answers from a corpus of past answers. In one embodiment, a computer-implemented method comprises a pre-processing process and a new multi-stage ranking process, in which a first stage is an initial retrieval and a second stage is a re-ranker stage.
Pre-Processing Process: The pre-processing process is focused on cleaning and processing domain-specific telecom data. In one embodiment, the pre-processing process includes expanding acronyms and abbreviations, removing of punctuation, removing numbers, and removing special tokens, etc.
Initial Retrieval Stage: This stage is focused on creating a fixed size embedding of a query comprising a TR observation (and optionally supporting information such as, e.g., header text from the TR and/or a faulty area as described below, which will further improve accuracy) and of past answers to past TRs. In one embodiment, the initial retrieval stage separately processes the (pre-processed) query and the (pre-processed) past answers using a representation-based model. In one embodiment, the representation-based model is a representation-based BERT model such as, e.g., Sentence-BERT [10], EPIC [20], RepBERT [21], ANCE [22], ColBERT [23], or the like. Note that XLNet is one example non-BERT based model that may alternatively be used. In one embodiment, both pre-processing and initial retrieval for the past answers is performed in advance (i.e., prior to processing the query) such that latency of the initial retrieval stage is substantially reduced. As a result of this reduction in latency, the use of BERT-based methods for initial retrieval becomes possible while keeping latency at an acceptable level (e.g., on the order of milliseconds, seconds, or a few minutes rather than hours). Once the embedding of the new query is created and the embeddings of the past answers are created or obtained (e.g., from storage or memory), the similarity between the query (including the observation text from the TR) and the answer text of each past answer is found by computing a respective similarity metric. The past answers can be a fixed list or can be updated over time, as described below in more detail. The past answers are then ranked according to the respective similarity metrics. The similarity metrics may be, for example, cosine similarity metrics, inner product (or dot-product) similarity metrics, Euclidean distance metrics, or the like. Note that some models (e.g., ColBERT) represent sentences as matrices, and for these types of models the similarity metric used may be, e.g., a sum of maximum similarity computations

$${S}_{q , d} := {\sum }_{i ∈ [ \vert {E}_{q} \vert ]} {max}_{j ∈ [ \vert {E}_{d} \vert ]} {E}_{qi} \cdot {E}_{{d}_{j}}^{T}$$

where E_{q} is the representation of the query and Ed is the representation of the document. A candidate list of the top-K (where K is typically an integer in the range of, e.g., 10-50, so top-K where e.g., K=10 means a list of the 10 best candidates) answers is given to the re-ranker. The value of K may be predefined or preconfigured. In one embodiment, the value of K is optimized for achieving a highest possible accuracy while also maintaining latency below a maximum acceptable amount of latency. Other examples of how to select K are described below.
Re-Ranker: This stage is focused on processing the (pre-processed) query (which includes the observation text from the TR) and the top-K candidate list of past answers to provide a final ranked list of candidate answers. To do so, in one embodiment, the re-ranker uses a two-input classification BERT architecture (e.g., monoBERT [11], duoBERT [11], CEDR [29], monoT5 [30], or the like). The (pre-processed) query and (pre-processed) past answers in the candidate list of past answered output by the initial retrieval stage are forwarded to the re-ranker, which then outputs a more refined similarity measure (compared to the initial retrieval stage) for each of the top-K candidate past answers. This similarity measure is used to re-rank the top-K past answers to create a more accurate final ranked list of length N, where N≤K. In one embodiment, the value of K is optimized for achieving a highest possible accuracy while also maintaining latency below a maximum acceptable amount of latency. In another embodiment, the re-ranker stage includes an ensemble of models (e.g., an ensemble of BERT-based models), as described below in more detail.

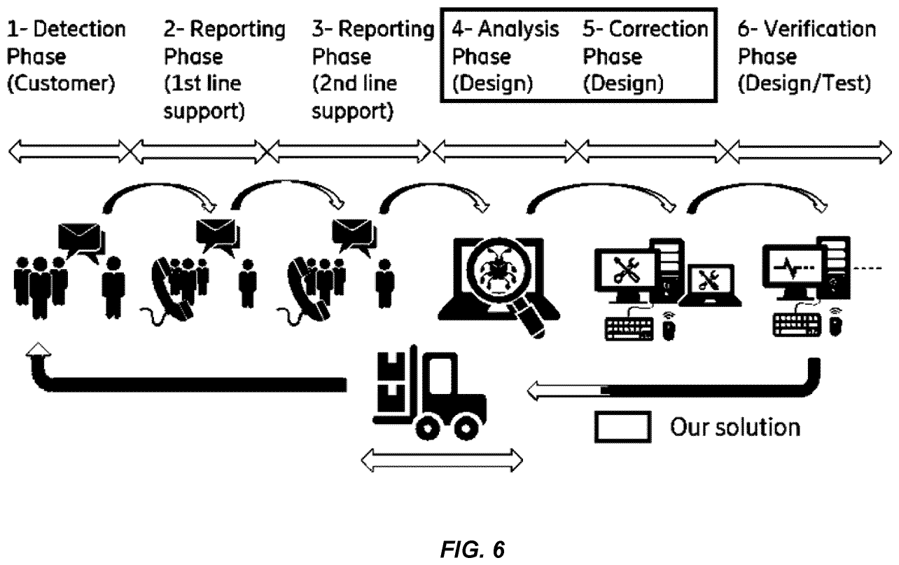

In one embodiment, the proposed method automates the analysis and correction phases of the troubleshooting process as depicted in FIG. 6.

Certain embodiments may provide one or more of the following technical advantage(s):
highly reduced computational complexity as compared to the hard decision-making task by not directly using a re-ranker and first having an initial retrieval stage,
improved accuracy as compared to prior methods as a result of bridging the sematic gap between the observation text and the answer text by not using classical methods that require a high degree of literal match between the query and answer,
decreased latency in inference time while keeping the performance at an acceptable level,
higher accuracy than non-BERT methods due to use of BERT-based approaches in both stages,
enabling an increase in the number of documents in the corpus without severely affecting the latency at inference time thanks to the initial retrieval stage and a candidate list of fixed length,
flexibility with respect to latency constraints where the number of components in the re-ranker stage can be optimized based on the latency-accuracy tradeoff. That is, the proposed solution can achieve better accuracy if needed at the cost of higher latency in the process (if this is acceptable),
enables recommendation of the same answer to similar TRs even though they might be written using different words or are described in different ways in different length. Furthermore, this information may be used to find duplicate TRs and process them faster,
can handle complex data which is domain-specific and/or company-specific,
enables decrease in processing time and computational complexity to fit the design latency constraint at inference time,
can identify duplicate and similar TRs without any extra components. In other words, it can suggest similar results to queries (observations) written in different words and length if they are similar.

### 1 Overview

Systems and methods are disclosed herein for retrieving the best possible answers to an observation from a (e.g., telecom-domain) TR. A new learning component referred to herein as a “text ranking system for trouble reports” is disclosed herein. In operation, data from past TRs is processed in order to retrieve the best possible candidate answers from a corpus of past answers, given a new observation of a fault. The systems and methods disclosed herein achieve high accuracy while keeping the computational complexity and latency of the process low.

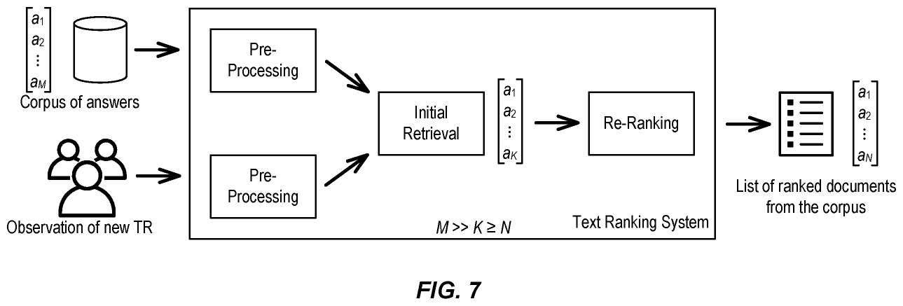

FIG. 7 illustrates stages of a process performed by a text ranking system 700 for retrieving a list of candidate answers to a query comprising observation text from a (e.g., new) TR from a corpus of past answers in accordance with one embodiment of the present disclosure. As illustrated, the process has three main stages:
Pre-Processing Stage 702: The pre-processing stage 702 cleans the data (i.e., the query and the past answers) to prepare the data for the next stage.
Initial Retrieval Stage 704: The initial retrieval stage 704 retrieves an initial list of candidate answers for the query from the corpus of past answers for past TRs.
Re-Ranker Stage 706: The re-ranker stage 706 ranks the answers in the list of candidate answers provided by the initial retrieval stage 704 and outputs a final list of ranked answers.

In one embodiment, the process can be changed to satisfy a desired latency constraint. In another embodiment, the process can provide the final list of ranked answers for new TRs using the minimum time possible with acceptable accuracy. In another embodiment, if more latency can be tolerated, the complexity of some of the stages can be increased in order to gain more accuracy (e.g., the re-ranker stage 706 can be implemented as an ensemble of BERT-based models).

The following subsections focus on each aspect of the ranking process, starting with the input and the data, then explaining the pre-processing, initial retrieval, and re-ranker stages, and finally commenting on the output of the process. Further subsections discuss aspects related to the training of the various models utilized in the process and inference, as well as provide some examples of the results.

### 2 Input and Data

The language of TRs is domain-specific (e.g., telecom-specific) and oftentimes also company-specific. Therefore, the language included in TRs is very different from a normal general-domain text such as the text found on Wikipedia. Most text ranking models are aimed at general language, but the text ranking process described herein is aimed at domain-specific data. In the following description, telecom data is oftentimes used as an example, but the process can be adapted to other domains as well.

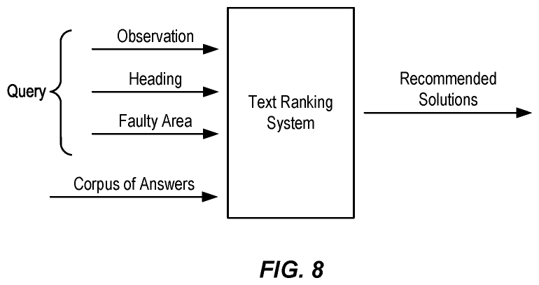

The general layout of a TR (as well as bug reports in general) is that it has some structured fields. As illustrated in FIG. 8, in the example embodiments described herein, main fields of a TR include:
Heading/Subject (Optional)—A short sentence giving a summary overview description of the problem
Observation—A longer text describing the observed behavior at problem time and any useful information for its solution is provided (logs, configuration, HW versions, etc.). The observation text is typically guided by a template that describe sections of the observation text
Answer—A longer text that is filled in when the TR is solved, and the solution is known. The answer contains the resolution given to the fault as well as the reason for the fault. The answer section can also be guided by a template
Faulty Product (Optional)—the specific code of the product on which the fault is reported. This is a “best effort” field and is typically on a very high level. Not detailed enough for detailed pinpointing of the problem. There are hundreds of different products, but the products can be sorted into “Faulty Areas” by creating a field derived from the product names which we call “Faulty Area”.
Faulty Area (Optional)—The Faulty Area is a derived text field, which in one embodiment includes or consists of a token that represents a general technology area (e.g., product area) that the TR affects. In one embodiment, the Faulty Area is derived using a raw information included in a new TR such as, e.g., information of the faulty product(s) on which the TR is reported.
   Note that different systems have different information available. So, depending on the information available at query time in the TR system, the input of the system can be just the heading, the observation, and the answers, as an example. In another example, as illustrated FIG. 8, input of the system includes the Heading, the Observation, and the Corpus of Answers (answers), as well as the Faulty Area. In the embodiments described herein, and illustrated in FIG. 8, the Heading/Subject is appended together with the Observation text and optionally the Faulty Area to form a Query (i.e., a text query). In order for the method of the present disclosure to work properly, it is preferable to have a clearly separated Observation and Answer section in the ticketing system.

A TR, once its status is finished, contains a substantial amount of information. There are many challenges with the data included in a TR such as, for example:
Not all sections of the TR follow the same template, and not all organizations use the same templates (even within the same company)
   Each template may have different fields that should filled in
   Engineers can ignore or remove the templates and write according to their own ideas
The length of each TR can differ
   This means that the system must be able to cope with variable length input
TRs might have lots of noise such as punctuations, links, or software code, configuration information, machine generated logging information in various non-standardized formats (key-value pairs, JSON, uuencoded binary data, etc.)
The language contained in TRs is not only domain-specific, but oftentimes also company-specific. Company specific text may contain, e.g.:
   specific product names
   Variable names specific to company products
   Company specific nomenclature
   Addresses
   Company specific abbreviations

To emphasize and show the specifics of the data that can be included in a TR, an example TR is included below. First, an example observation in a TR is:

### 1. Description

A crash with the signature below took place on a site after upgrade to MTR20.19-9, when unlocking the cells. 2020-06-01 11:15:30 LPMD 0001 DUS5301 Restart request Rank=Warm Sig=SIGABRT Proc=/home/sirpa/software/RPF-PPF-C1-ARM-WR18-TRINITY_CXP2010204_1_R22C60/rpcBbrsNrLocalArmWr18/bin/rpcBbrsNrLocalArm File=pmd-rpcBbrsNrLocalA-11495-20200601-111530.tgz.gpg_with_llog.tgz Extra-Recovery action initiated by BB via BCI, faultId: 0x301 (SwError), faultDescription: Emca 1:DSP 8: “CM Alloc error; zero size/too large brpc/baseband_resource_set/handler/src/eqmhi_baseband_state_machine_impl.cc:1136
2. Frequency and number of nodes affected
Happened once on a live site
3. Lgp output (lgg for RU crash)
2020-06-01 11:15:30 LPMD 0001 DUS5301 Restart request Rank=Warm Sig=SIGABRT Proc=/home/sirpa/software/RPF-PPF-C1-ARM-WR18-TRINITY_CXP2010204_1_R22C60/rpcBbrsNrLocalArmWr18/bin/rpcBbrsNrLocalArm File=pmd-rpcBbrsNrLocalA-11495-20200601-111530.tgz.gpg_with_llog.tgz Extra=Recovery action initiated by BB via BCI, faultId: 0x301 (SwError), faultDescription: Emca 1:DSP 8:“CM Alloc error; zero size/too large brpc/baseband_resource_set/handler/src/eqmhi_baseband_state_machine_impl.cc:1136

Next, the corresponding answer to this observation is, in this example:

### CAUSE OF FAULT

The crash was only observed once, and dump post-mortem analysis gave us an hypothesis for the fault but nothing could be confirmed without reproduction of the issue.
With that said, the likely cause was a BEN wraparound bug when starting synchronized timers in the scheduler. IF this is in fact the case, this would be the mechanism: two different actors each start their own timer on either side of a BEN boundary.
Both get a signal to start their timers, both read “current BEN”, both compute the starting point of the next BEN so that they start at the same time. But their “current BFN” reading might differ slightly, and in the worst case one of them is already in the next frame. That actor will then not start its timer until one whole frame later than the other actor. This means that the “late” actor will not free memory which it's responsible for freeing, leading to a crash.

### KPI/SYSTEM IMPACT

Crash during startup.

### SOLUTION

Instead of allowing both actors involved to read “current BEN” independently, they both get sent a BEN which represents the “current BFN” at the time of cell setup. This BEN is stepped two frames into the future, which should cover the time necessary for these signals to propagate. Then both actors can set up their timers to start at this future BEN, and be guaranteed that they start at the same time.
This solution was verified to cause no harm on sub-node and node test levels, but since the crash itself was never reproduced, we have not verified that this is in fact the true problem.

### OTHER INFORMATION

Fault Slip Through analysis, 2 questions.
Insufficiently rigorous analysis of concurrency problems.
No new test introduced because this issue is very difficult to reproduce.
As seen in the example TR above, the observation text is not general language, and it contains many abbreviations as well as company-specific and domain-specific language. The embodiments of the text ranking system 700 and process described herein are able to handle this type of complex data.

The two main inputs in a text ranking model are the query and the corpus of documents. In the embodiments of the process described herein, the corpus of documents is or consists of the answers of past TRs, and the query includes the observation and optionally additional information such as, e.g., the heading of the TR and the Faulty Area.

### 2.1 Mapping of TR Faulty Area

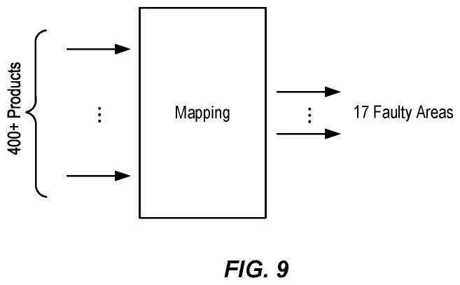

The Faulty Area is a synthetization of the Faulty Product for which the TR is submitted, where the Faulty Product can be any one of a number of different products. In one example, there may be hundreds of products for which a TR may be submitted. In one embodiment, by analyzing past (i.e., historical) TRs, a set of Faulty Areas is created, and then the products are mapped to these Faulty Areas, as illustrated in FIG. 9. Then at query time for a new TR, the Faulty Product for which the TR is submitted is mapped to the respective Faulty Area, and this Faulty Area is then included in the query. In one example embodiment, the mapping of Faulty Products to Faulty Areas is implemented as a hard-coded rule-based mapping prior to the pre-processing stage 702. In another example like in [2], could the mapping is implemented as a ML based model.

Thus, in one embodiment, the Faulty Area for a TR is determined using the above-described mapping, and the Faulty Area is included in the query, together with the observation and optionally the heading from the TR. Adding the Faulty Area improves the accuracy of the text ranking system 700. Other similar information could also be added to the query, depending on what is available at query time in the ticketing system (i.e., the system for creating and submitting a TR).

### 3 Pre-Processing Stage

The pre-processing stage 702 is focused on preparing the data (i.e., the query and the past answers) for the initial retrieval and re-ranking stages. As stated, the language in the example embodiments described herein is both telecom-specific and company-specific, and therefore, it needs specific pre-processing steps.

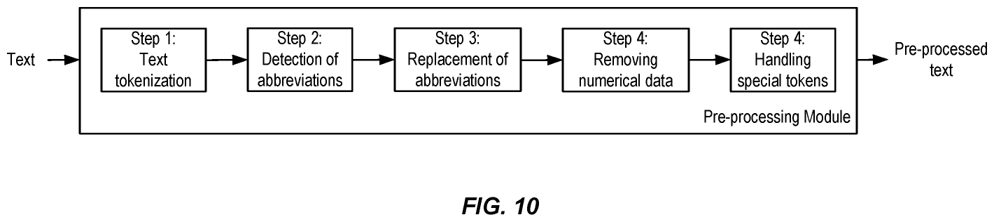

FIG. 10 illustrates the steps of the pre-processing stage 702 in accordance with one embodiment of the present disclosure. In one embodiment, the pre-processing stage 702 includes a Spacy Language Processing pipeline (or the like) where custom cleaning modules are added. The custom cleaning modules are, in the illustrated example:
Step 1, Text tokenization: All text in the query is tokenized (e.g., broken into words, sub-words, or the like) with a custom tokenizer that recognizes company-specific and domain-specific language.
Step 2, Detection of abbreviations: In this step, abbreviations and acronyms are detected and tagged with a customized Name Entity Recognition (NER). The NER is trying to find patterns for company products as well as build gazetteer for hardware (HW)/software (SW) databases. A gazetteer consists of a set of lists containing names of entities such as cities, organizations, days of the week, etc. These lists are used to find occurrences of these names in text, e.g. for the task of named entity recognition. Note that this step is customized such that company-specific and/or domain-specific acronyms can be detected.
Step 3, Replacement of abbreviations: In this step, the detected and tagged abbreviations and acronyms by the complete words. In case of multiple suggestions for a given abbreviation, the first suggestion which is most related to the domain or company is selected. Note that steps 2 and 3 may be performed using, e.g., predefined or preconfigured company-specific and/or domain-specific input (e.g., a list(s) of company-specific and/or domain-specific abbreviations and acronyms and their corresponding complete words).
Step 4, Removing numerical data: In this step, any numerical tokens are removed as they do not provide any useful information to an NLP model.
Step 5, Handling special tokens: In this step, special tokens such as, e.g., extra spaces, new lines, and gaps between words as well as any punctuation signs are removed.

### 4 Initial Retrieval Stage

The properties of the initial retrieval stage 704 are:
It has low latency and can manage large amounts of data.
It produces a candidate list of past answers that are relevant to the query.
The candidate list of past answers produced by the initial retrieval stage 704 contains all relevant documents, i.e., it has a high recall. The position of relevant documents in the ranking does not matter. They should be included in the list.

The output of the initial retrieval is a list of the top K past answers. This list is also referred to herein as an initial candidate list or an initial list of candidate (past) answers. The initial candidate list can be constructed in many ways as it is explained in Section 4.1.

In one embodiment, the initial retrieval stage 704 comprises a representation-based architecture. The representation-based architecture is, in one embodiment, a representation-based BERT architecture. In one particular embodiment, the representation-based architecture is a sentence-BERT architecture. However, other similar types of architectures may be used (e.g., EPIC, RepBERT, ANCE, ColBERT, or the like). This type of architecture (other than ColBERT) creates a dense vector representation for the query and a dense vector representation for each of the past answers. Note that if ColBERT is used, it creates dense matrix representation. In one, non-limiting, embodiment such vector may comprise 700 numbers. In yet another embodiment, the representations of the query and the answers are calculated separately. This is advantageous in terms of reducing latency as described in section 8 below. Importantly, by processing the query separately from the past answers, the past answers can be pre-processed by the pre-processing stage 702 and dense vector representations of the pre-processed past answers generated in advance (i.e., prior to processing of the query for a new TR) and stored for subsequent use. In this manner, the latency of the initial retrieval stage 704 is substantially reduced, which in turn enables the use of BERT-based methods for the initial retrieval stage 704 in order to improve accuracy while also having low latency. Note that the pre-processed past answers may be updated, e.g., periodically, in longer time intervals.

After the representations of the query and the corpus of past answers are computed, a similarity score is calculated between the query and each past answer by using a similarity metric, which may be, for example, the cosine similarity, inner-product (or dot-product) metrics, Euclidean distances, or the like. Using cosine similarity as an example, the cosine similarity can be computed using the following formula, where Q is the representation of the query and A is the representation of the past answer and both Q and A are fixed-size vectors:

$$sim ( Q , A ) = \frac{Q \cdot A}{‖ Q ‖ \cdot ‖ A ‖} .$$

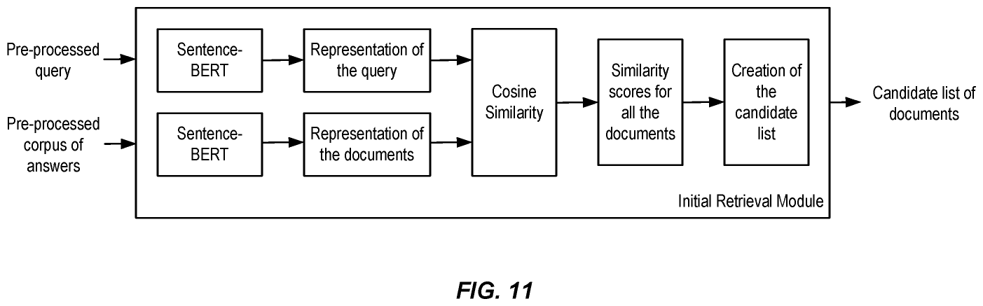

FIG. 11 is a functional block diagram that illustrates one embodiment of the initial retrieval stage 704. A representation-based model 1100 (e.g., a representation based BERT model such as, e.g., Sentence-BERT [10], EPIC, RepBERT, ANCE, ColBERT, or the like) is used to compute the representations of the pre-processed query and each of the pre-processed past answers. In the illustrated example, the representation-based model 1100 is a Sentence-BERT and as such as denoted as a Sentence-BERT model 1100 in FIG. 11. Note that if ColBERT is used, the similarity metric is one that is suited for matrices. As noted above, the representation of each of the pre-processed past answers is, in one embodiment, computed in advance and stored for subsequent use to compute the similarity metric values with respect to the subsequently received query. Similarity metric values are computed, by a cosine similarity function 1102, for the similarities between the representation of the pre-processed query and the representations of each of the pre-processed past answers. Then, the list of candidate answers is created, by a creation function 1104, based on the similarity metric values. In one embodiment, the past answers having the top-K similarity metric values are selected for the list of candidate answers.

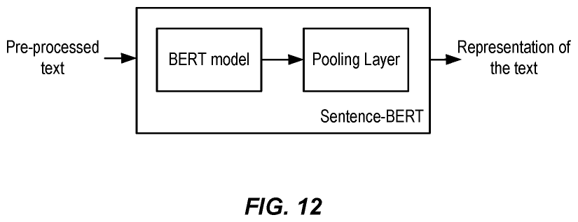

One embodiment of a possible representation-based model that includes BERT is Sentence-BERT [10]. Thus, in one embodiment, the representations of the pre-processed query and each of the pre-processed past answers created for the initial retrieval stage 704 uses sentence-BERT. As illustrated in FIG. 12, sentence-BERT is composed of two main layers: first a BERT model 1200 and then a mean pooling layer 1202. The mean pooling is performed on the output of the BERT model. The final output provided by the sentence-BERT model is a fixed-size vector used to compute the cosine similarity. A possible BERT model that can be used in the first layer of the Sentence-BERT is DistilROBERTa-base [13]. This specific BERT model has a good performance and a low complexity compared to others. However, other BERT-based models may be used (e.g., ELECTRA, DisitilBERT, ROBERTa, AlBERT, etc., where they substitute the BERT model inside the BERT-based architectures).

This approach mixes a very fast architecture, representation-based models, with the use of the contextual embeddings from BERT. It is a low latency model that takes advantage of the accuracy of BERT models.

As discussed above, in one embodiment, the latency of the initial retrieval stage 704 is significantly reduced by computing and storing the representations of the corpus of past answers in advance (e.g., after a training phase but, e.g., prior to inference time), rather than at the inference time. In this way, the only representation needed to be computed at the inference time is the representation of the pre-processed query. Then, the similarity metric value between the representation of the query and each of the pre-saved representations of the pre-processed past answers is computed. However, the corpus of answers may not be fixed. If new answers of TRs are added to the corpus of past answers, then, in one embodiment, then new answers of TRs added to the corpus of past answers are pre-processed and corresponding representations are generated, e.g., periodically, e.g., after training phase but before the inference time. This is not a problem since, during the training phase, latency is not an issue. Latency is only crucial at execution time.

According to embodiments, the training phase is initiated by that the BERT models are trained. In general terms, the training consists of teaching the BERT models how to create the best possible representation of queries and answers, so that a query and an answer that are relevant to each other have a similar representation. For that, a training dataset of TRs is used. After a model is trained, the representation of the corpus of answer is computed. The TR data in the training dataset and the data in the corpus of answers is different. The training phase can take several days, while at execution time, it is preferable to limit the execution time to minutes or even seconds.

The output of this the initial retrieval stage 704 is a candidate list of the top-K past answers. This list can be created following many strategies as described in the following Section 4.1.

### 4.1 Creation of the Candidate List

Once a similarity metric value (also referred to herein as a similarity score) for each past answer in the corpus has been computed, the candidate list can be created in many ways. One option is that the candidate list length is a fixed number (i.e., K is a fixed number and the candidate list includes the top-K past answers). Another option is that length is a hyper-parameter that can be tuned (e.g., the value of K can be tuned). A third option would be to use a threshold score and include in list all the answers that had a score above this threshold (i.e., using a similarity threshold and including all answers that have a similarity metric value that is greater than this threshold).

The number of past answers included in the candidate list and provided to the re-ranker stage 706 will have an effect on the latency of the whole process. That is why choosing a good size for the candidate list is important.

### 5 Re-Ranker Stage

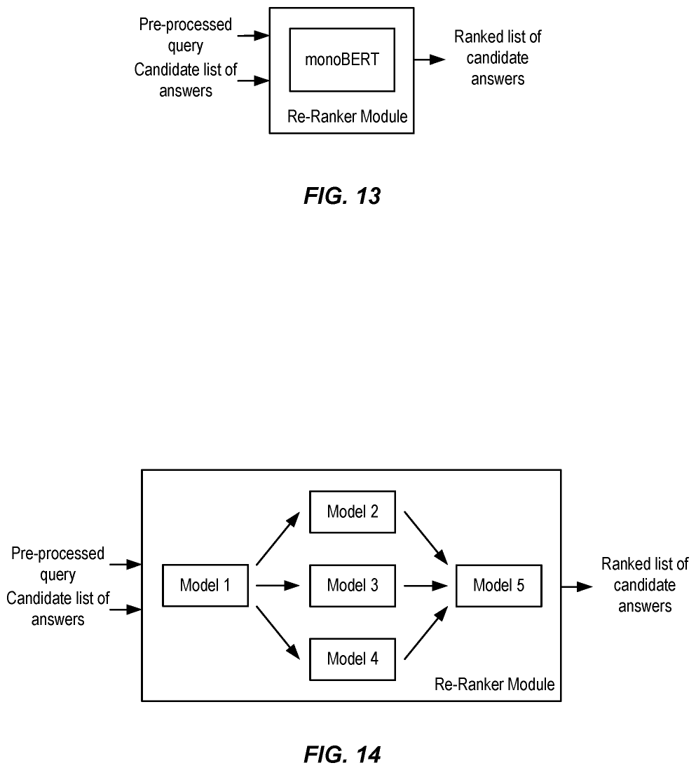

Example embodiments of the re-ranker stage 706 are shown in FIGS. 13 and 14. As illustrated in FIG. 13, in one embodiment, the re-ranker stage 706 is implemented by a single model. For example, the single is, e.g., a single BERT-based model such as, in this example, a monoBERT model 1300. However, other examples that can be used for the single model are duoBERT, CEDR, monoT5, or the like. As illustrated in FIG. 14, in another embodiment, the re-ranker stage 706 is an ensemble of models 1400-1 through 1400-5 in this example (e.g., BERT-based models) consisting of different small re-rankers that can be stacked together in serial and/or in parallel.

The properties of the re-ranker stage 706 are:
It is a slower and more complex stage as it only needs to focus on the candidate list of answers provided by the initial retrieval stage 704 and not the whole corpus of past answers.
It produces a ranking score for each past answer in the candidate list and, as an output, it gives a shorter top-N list of highly relevant past answers as a final candidate list.

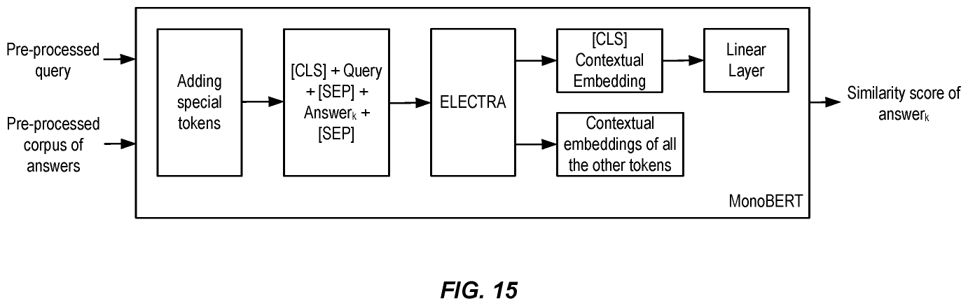

In one example, the model used in the re-ranker stage 706 is a BERT model with high accuracy, such as monoBERT [11], which is depicted in detail in FIG. 15. MonoBERT is a two-input classification BERT model with a linear layer on top. The input of this model is composed by the pre-processed query, one of the pre-processed answers from the candidate list received from the initial retrieval stage 704, and the special tokens: [SEP] and [CLS]. Once this sequence (i.e., [CLS]+Query+[SEP]+Answer+[SEP]) is tokenized, it is passed through the BERT model (e.g., ELECTRA in this example, but other examples include AlBERT, ROBERTa, DistilROBERTa, etc.) which creates contextual embeddings for all the tokens. Next, the monoBERT model takes the contextual embedding of the [CLS] token and forwards it to a single linear layer that outputs a scalar value indicating the probability of the answer being relevant to the query. This process is repeated for each of the past answers included in the candidate list. The probabilities output by the monoBERT model for the past answers in the candidate list are used as similarity measures to re-rank the past answers in the candidate list and output the final list of ranked (past) answers. The BERT model used in this example is ELECTRA [14], but other BERT models may be used (e.g., AlBERT, ROBERTa, DistilROBERTa, etc.).

In another example, an ensemble of BERT models with lower latency can be used, where possible examples of BERT models are TinyBERT [15] or DistilBERT [13]. These are BERT models with lower latencies and lower accuracies which results can be combined in an ensemble way to boost their performance. Different methods to combine the results (e.g., similarity score) for each model includes maximum voting, averaging, stacking and linear optimization for computing the best weights for each model.

Deciding how complex the re-ranker module should be is a flexible choice that depends on the latency constraint for the particular implementation.

### 6 Output

Given a new TR that is input into the text based ranker system/process, the output is a ranked list of answers relevant to the TR and its dimension is N≤K. This ranked list of answers is, e.g., given to the support engineers in charge of solving the TR.

### 7 Training

The models used in both the initial retrieval stage 704 and the re-ranker stage 706 need training to achieve good performance on domain-specific and company-specific data. The model(s) used for each of these stages is trained separately as each model requires a different type of training.

For example, if Sentence-BERT is used in the initial retrieval stage 704, a model is obtained that has already been pre-trained using an existing dataset such as, e.g., the MSMARCO dataset [16] which can be found in the Hugging Face repository [17]. Then, this model is fine-tuned to work with domain-specific and/or company-specific data using a training set of troubleshooting data. In another example, general troubleshooting data, or more specific data, such as TR related to telecom networks can be used for fine-tuning the model. As an example, a training set composed of 11,000 observation and answer pairs, which are input into the model in batches, may be used for training, where, e.g., the loss used is the Multiple Negative Ranking Loss and the model is trained for, e.g., 8 epochs, using a learning rate of, e.g., 6·10⁻⁵ with a linear warm up.

In the re-ranker stage 706, if the monoBERT model is used, a model is obtained that has been pre-trained using an existing dataset such as, e.g., the MSMARCO dataset which can be found in the Hugging Face repository [17]. This model is fine-tuned using the training set of the troubleshooting data. For example, a training dataset that is composed of 11,000 observation and answer pairs, as well as 33,000 observation and non-relevant answer pairs, may be used for training, where the loss used is, e.g., the Cross-Entropy Loss and the model is trained for, e.g., 4 epochs using a learning rate of, e.g., 2·10⁻⁵ and a linear warm up.

Note that, during training, samples of importance may be repeated in the training dataset in order to increase their importance. In one embodiment, different samples have different levels of importance and may be repeated different numbers of times in the training dataset.

### 8 Execution/Inference

In one embodiment, the operation of the text-based ranking system discussed herein at inference time is as follows. A fault is detected by a customer or during internal testing and a TR is submitted. A query is created from the TR, where the query includes the observation text from the TRA and optionally additional data such as, e.g., the heading from the TR and/or the Faulty Area determined based on the TR, as described above. In one embodiment, the query is created by concatenating the faulty area, the header, and then the observation.

In order to reduce the latency of the process in the initial retrieval stage 704, in one embodiment, a fixed size representation of each of the past answers in the corpus is pre-computed (e.g., during training) and stored for subsequent use in the initial retrieval stage 704. That way, at inference time, the only representation needed to be computed is the representation of the new query.

Once the representation of the new query is computed, the initial retrieval stage 704 computes similarity metric values that represent the similarity between the query and different past answers, as described above. The candidate list of answers (e.g., the top-K past answers) is created based on the computed similarity metric values and, in some embodiments, a cut off threshold (e.g., K). Examples of this cut off number/threshold are explained in Section 4.1 above. The value of this cut-off number/threshold may be used to reduce the computational complexity for the re-ranker stage 706.

In one embodiment, the pre-computed fixed size representations (also referred to herein as embeddings) of all the past answers in the corpus are updated periodically due to new incoming TRs for initial retrieval phase and the rest of process is similar to the prior example.

In the re-ranker stage 706, the top-K candidate list is received. For example, the top-15 answers may be used as the input to the re-ranker stage 706, as 15 is a value that achieves good performance while keeping the computational complexity and latency low. The re-ranker outputs a final ranked list of answers, as described above. This final ranked list is used to recommend N past answers as possible answers to the observation of the new TR. The number of proposed answers in the final ranked list is a design parameter that is equal or smaller to the candidate list length (i.e., N≤K). As an example, N=5 can be used as it is a reasonable number of answers to recommend.

At inference time, it is important that the computations of the re-ranker are limited as much as possible. Having an initial retrieval that outputs a candidate list allows this to happen, as the re-ranker only processes K answers instead of M answers (K<<M), where M is the total size of the corpus of answers at inference time. By having the two stages and pre-saved representations of the M answers, a forward pass through a BERT model is needed only one time (at initial retrieval for the query) and K times (at re-ranker for each candidate), for a total of 1+K. If the initial retrieval state was not used, then the forward pass-through BERT would need to be done once for every answer in the corpus, i.e., a total of M times. The reduction in calculations is significant: 1+K<<M. For example, K=15 may be used for a corpus of, e.g., M=2500 answers. As can be calculated, the reduction in complexity is significant: 1+15<<2500, while a high accuracy is still achieved.

The calculations of the re-ranker stage 706 cannot be pre-saved as the input for a two-input classification BERT model is query+answer₁, query+answer₂, . . . , query+answer_{K} as shown in FIG. 15. While at initial retrieval the inputs are the query and answers, separately.

By using a multi-stage retrieval with a K<<M, the size of the corpus M can be significantly increased without harming the computational complexity at inference time.

### 9 Example of Results

An example implementation of the text-based ranking system and process described herein has been tested using a dataset of TRs. For each observation in the test set, the correct answer is known, and it is checked if this answer is placed in a high position in the resulting candidate list. The metrics used to evaluate the method are the Recall@K and the Mean Reciprocal Rank (MRR). In the setup used for the test, Precision@K is not a valid metric for performance evaluation as there is only one correct answer for each observation. Recall@K answers if the correct answer is in the top-K answers of the candidate list. For example, if we have a list of all the answers ranked with respect to their similarity score, the value of the Recall@3 would state if the correct answer is in the top-3 positions of the ranked list (it doesn't matter at which position it is, it only matters if it is inside this top-3 list). MRR is a measure of the position of the correct answer in the ranked list. If the correct answer is at position 1 the MRR will be 1, if the correct answer is in position 3, the MRR will be ⅓, and so on.

The results of the test set for the two stages are included to state that there is an improvement of the results after the second stage. Keep in mind that while the initial retrieval stage 704 receives all the corpus of answers, the re-ranker stage 706 only receives the candidate list of length K, that in our case is 15. So, the results of the second stage are limited to the results of the first stage.

TABLE 1
Results of the initial retrieval and the re-ranker using K = 15.

| | | Initial Retrieval + |
|---|---|---|
| | Initial Retrieval | Re-Ranker |
| Recall@1 | 30% | 36% |
| Recall@3 | 43% | 48% |
| Recall@5 | 49% | 53% |
| Recall@10 | 58% | 60% |
| Recall@15 | 64% | 64% |
| MRR | 0.39 | 0.44 |

As can be seen in Table 1, there is a significant improvement, especially in the first positions by using the two stages. We are always forwarding 15 candidates to the re-ranker stage 706, which is why the values for the Recall@15 are the same in the two stages.

To see if the results for the initial retrieval were generalizable, a k-fold cross-validation was performed with k=5 (here small “k”, is the number of folds in the cross validation, not the K in Recall@K) and the results can be seen in Table 2. There is also a comparison of the results for the initial retrieval using the Faulty Area and not using it.

TABLE 2
Cross-validation results of the initial retrieval and
comparison between using the Faulty Area or not.

| | | Not using the Faulty |
|---|---|---|
| | Using the Faulty Area | Area |
| Recall@1 | 28% | 26% |
| Recall@3 | 40% | 37% |
| Recall@5 | 47% | 43% |
| Recall@10 | 56% | 51% |
| Recall@15 | 61% | 56% |

As seen in Table 2, the usage of the Faulty Area implies a significant improvement in the results, and it is an element of novelty in the way queries are constructed in text ranking systems for telecom domain- and company-specific data. We want to emphasize the difference it makes in the performance using a word at the beginning of the query that describes the faulty area.

Finally, the results of the re-ranker have also been cross-validated and can be seen in Table 3, in the third column.

TABLE 3
Cross-validated results of the initial retrieval and re-ranker stages.

| | | Initial Retrieval + |
|---|---|---|
| | Initial Retrieval | Re-Ranker |
| Recall@1 | 28% | 33% |
| Recall@3 | 40% | 46% |
| Recall@5 | 47% | 51% |
| Recall@10 | 56% | 58% |
| Recall@15 | 61% | 61% |
| MRR | 0.37 | 0.41 |

As stated in these tables, the method we propose is able to retrieve the correct solution for the test set of the troubleshooting reports dataset with high accuracy.

Moreover, we have compared our solution to a baseline model. The baseline model implemented is the BM25 as it is used in many papers as a baseline initial retrieval. We will compare the results of using BM25 in initial retrieval, instead of Sentence-BERT.

TABLE 4
Result of initial retrieval using BM25 instead of Sentence-BERT.

| | Initial Retrieval |
|---|---|
| Recall@1 | 18% |
| Recall@3 | 24% |
| Recall@5 | 27% |
| Recall@10 | 31% |
| Recall@15 | 33% |
| MRR | 0.22 |

As shown in Table 4, the results of using BM25 instead of Sentence-BERT are significantly worse. The improvement of using a BERT-based model in the first stage is 30 percentage points for Recall@15. This result shows the advantages of BERT-based models in terms of accuracy compared to more traditional approaches.

### 9.1 Latency Results

By using a multi-stage approach, the method disclosed herein is able to reduce the complexity significantly while maintaining a good performance.

TABLE 5
Complexity of the two main stages. The corpus of answers
was of 2000 and the candidate list was of 15 documents.

| | Initial Retrieval | Initial Retrieval + Re-Ranker |
|---|---|---|
| milliseconds/query | 28 | 578 |

Table 5 shows that the complexity of the whole model (i.e., the model for the particular implementation used for the test) is 0.5 seconds on average per query. If we just used the second stage without the initial retrieval, the complexity of the model would increase to minutes just for one query in the case of a corpus of 2000 answers. The complexity of the re-ranker increases proportionally to the length of the candidate list. By keeping the candidate list small, we are able to maintain this low latency while increasing the corpus.

### 9.2 Similar Trouble Reports Analysis for Evaluation of Results and Identification of Duplicates

There is a high probability that different customers individually raise different TRs for the same underlying problem but written with different observations. If it is not identified early, different teams might work on the same underlying issue but on different TRs. One of the purposes and advantages of the text-based ranking system/method disclosed herein is being able to recommend the same answers to similar TRs even though they might be written using different words or described in different ways. We use this as an evaluation of how well our model can recognize similar TRs.

Of all the TRs in our test set that we know are similar and that we are able to retrieve the correct answer in the top-5 candidate lists, we recommend similar answers to 70% of them. We have to keep in mind that we have not given the model any indication that there might be similar TRs. So, if the model can find similar TRs without the explicit training this means that it has learned the domain-specific company language and can make inferences about it.

This result can be used as a way to identify duplicate TRs, which is another important task in the process of troubleshooting. It can be done by analyzing which top-N solutions we are giving to two different TRs, if those solutions are equal or very similar, we could conclude that the TRs are duplicates and process them faster.

### 10 Additional Description

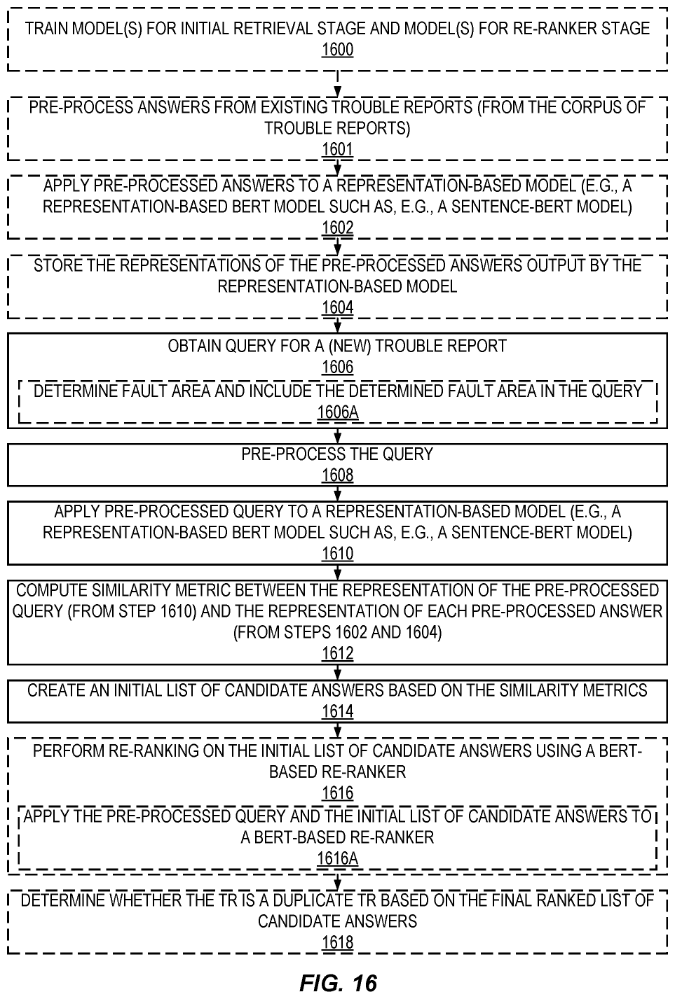

FIG. 16 illustrates a computer-implemented procedure for generating a ranked list of candidate answers for a query in accordance with at least some of the embodiments described above. Optional steps are represented by based boxes. As illustrated, the model(s) used for the initial retrieval and re-ranker stages are trained (step 1600). This training is performed based on a training dataset that includes a training dataset of TRs. In one embodiment, the models are trained (and fine-tuned) in three stages consisting of a first stage in which the models are trained based on general documents (e.g., documents such as articles found on Wikipedia), a second stage in which the models are further trained based on general question and answering texts (e.g., MSMARCO), and a third stage in which models are fine-tuned based on a training dataset of TRs, which include domain-specific and/or company-specific language. Additional information regarding the training of the models is included above.

After the models are trained, past answers from a corpus of TRs (i.e., answers from a collection of existing or past TRs) are pre-processed in the pre-processing stage 702, as described above (step 1601). The pre-processed past answers are applied to a representation-based model to provide representations (e.g., dense vector representations) of the pre-processed past answers, as described above with respect to the initial retrieval stage 704 (step 1602). In other words, the representations of the pre-processed past answers are computed using the representation-based model. As described above, the representation-based model is, in one embodiment, a representation-based BERT model. In one specific embodiment, the representation-based model is a sentence-BERT model. However, other examples of the representation-based model are EPIC, RepBERT, ANCE, ColBERT, or the like. As discussed above, the representation-based model has been trained (e.g., fine-tuned) based on an applicable domain-specific and/or company-specific dataset. In one embodiment, steps 1601 and 1602 are performed prior to receiving a query to be processed (i.e., prior to inference) and the representations of the pre-processed past answers are stored in associated storage or memory (step 1604). It is important to note that the architecture of the pre-processing and initial retrieval stages where the query and past answers are processed separately, enables pre-processing and generation of the representations of the past answers in advance of inference time and stored for subsequent use. As discussed above, by pre-computing and storing the representations of the pre-processed past answers, the latency of the initial retrieval stage 704 as well as the computational complexity of the initial retrieval stage 704 at the time of inference is significantly reduced. This enables the use of a BERT-based model for initial retrieval. Use of the BERT-based model enables better semantic understanding of the past answers (and also the query), which allows sematic matching rather than requiring exact matching. This improved sematic understanding significantly improves the accuracy of the initial retrieval stage 704 as compared to a scenario in which a pre-BERT method is used for initial retrieval. Further, by improving the accuracy of the initial retrieval stage 704, the number of past answers included in the initial list of candidate answers output by the initial retrieval stage 704 (see 1614 below) can be substantially reduced as compared to if a pre-BERT method were used. This, in turn, allows a more complex model to be used by the re-ranker stage 706 while maintaining latency within an acceptable range (e.g., milliseconds or seconds rather than many minutes or hours).

A query is obtained from a (e.g., new) TR (step 1606). As discussed above, the query includes observation text from the TR and, optionally, additional data such as, e.g., header text from the TR and/or a Faulty Area determined based on the product(s) for which the TR has been submitted (step 1606A). The query is pre-processed, as described above with respect to the pre-processing stage 702 (step 1608). The pre-processed query is applied to a representation-based model to provide a representation of the pre-processed query (step 1610). In other words, the representation of the pre-processed query is computed using the representation-based model. As described above, the representation-based model is, in one embodiment, a representation-based BERT model. In one specific embodiment, the representation-based model is a sentence-BERT model. However, other examples of the representation-based model are EPIC, RepBERT, ANCE, ColBERT, or the like. As discussed above, the representation-based model has been trained (e.g., fine-tuned) based on an applicable domain-specific and/or company-specific dataset. Note that the representation-based model used in step 1610 may or may not be the same model as used in step 1602.

A similarity metric is computed between the representation of the pre-process query and the representation of each of the pre-processed past answers (step 1612). Thus, a similarity metric is computed for each past answer that represents the similarity between that past answer and the query. The initial retrieval stage 704 then creates an initial list of candidate answers based on the computed similarity metrics (step 1614). As described above, in one embodiment, the initial list of candidate answers output by the initial retrieval stage 704 is a list of the top-K past answers, as determined based on the computed similarity metrics.

Re-ranking of the initial list of candidate answers is then performed at the re-ranker stage 706 to provide a final ranked list of candidate answers for the query or TR (step 1616). More specifically, as described above with respect to the re-ranking state, the initial list of candidate answers (more specifically the pre-processed past answers for those past answers included in the initial list) are applied to a BERT-based re-ranker model to provide the final ranked list of candidate answers (step 1616A). As described above, the BERT-based re-ranker model may be a single BERT-based model such as, e.g., a monoBERT model, duoBERT model, CEDR model, monoT5 model, or the like, or may be an ensemble of BERT-based models. The final ranked list of candidate answers may, in some embodiments, be provided to one or more engineers responsible for correcting the problem indicated in the TR.

In one embodiment, a determination may be made as to whether the TR for which the query is processed is a duplicate TR (step 1618). As described above, duplicate detection may be performed based on a comparison of the final ranked list of candidate answers generated for the query/TR and corresponding ranked lists of candidate answers generated (e.g., previously) for other queries/TRs. If the final ranked lists of candidate answers for two TRs match at least to a predefined or preconfigured threshold degree, then the two TRs are identified as duplicate TRs. In one embodiment, the two TRs may be flagged as duplicate TRs (e.g., in a database of TRs) and/or one or more persons may be notified of the duplicate TRs and/or the duplicate TRs may be combined into a single TR.

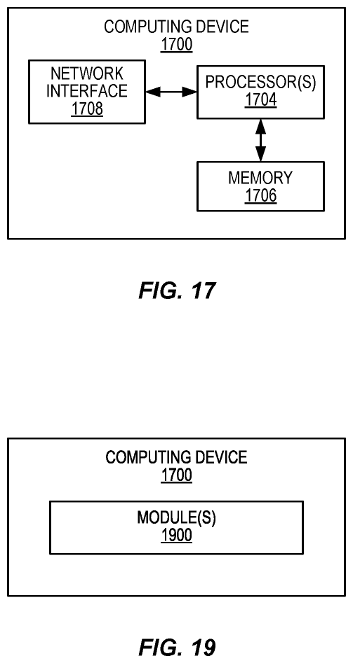

FIG. 17 is a schematic block diagram of a computing device 1700 according to some embodiments of the present disclosure. Optional features are represented by dashed boxes. The computing device 1700 may be, for example, a personal computer, a server computer, or the like. As illustrated, the computing device 1700 includes one or more processors 1704 (e.g., Central Processing Units (CPUs), Application Specific Integrated Circuits (ASICs), Field Programmable Gate Arrays (FPGAs), and/or the like), memory 1706, and a network interface 1708. The one or more processors 1704 are also referred to herein as processing circuitry. The one or more processors 1704 operate to provide one or more functions of the computing device 1700 as described herein (e.g., one or more functions of the computing device 1700 as described herein in relation to the procedure of FIG. 16). In some embodiments, the function(s) are implemented in software that is stored, e.g., in the memory 1706 and executed by the one or more processors 1704.

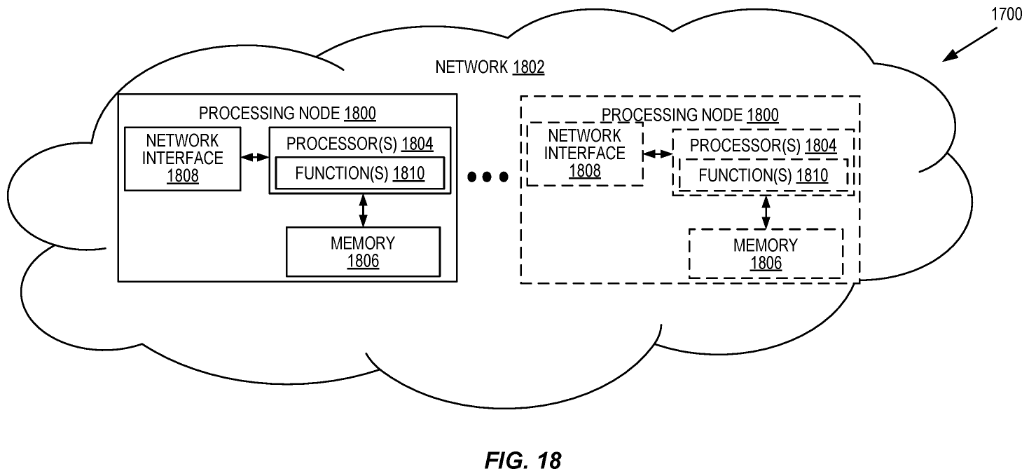

FIG. 18 is a schematic block diagram that illustrates a virtualized embodiment of the computing device 1700 according to some embodiments of the present disclosure. Again, optional features are represented by dashed boxes. As used herein, a “virtualized” computing device is an implementation of the computing device 1700 in which at least a portion of the functionality of the computing device 1700 is implemented as a virtual component(s) (e.g., via a virtual machine(s) executing on a physical processing node(s) in a network(s). As illustrated, in this example, the computing device 1700 is implemented by one or more processing nodes 1800 coupled to or included as part of a network(s) 1802. Each processing node 1800 includes one or more processors 1804 (e.g., CPUs, ASICs, FPGAs, and/or the like), memory 1806, and a network interface 1808. In this example, functions 1810 of the computing device 1700 described herein (e.g., one or more functions of the computing device 1700 as described herein in relation to the procedure of FIG. 16) are implemented at the one or more processing nodes 1800 or distributed across the two or more processing nodes 1800 in any desired manner. In some particular embodiments, some or all of the functions 1810 of the computing device 1700 described herein are implemented as virtual components executed by one or more virtual machines implemented in a virtual environment(s) hosted by the processing node(s) 1800.

In some embodiments, a computer program including instructions which, when executed by at least one processor, causes the at least one processor to carry out the functionality of computing device 1700 or a node (e.g., a processing node 1800) implementing one or more of the functions 1810 of the computing device 1700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 19 is a schematic block diagram of the computing device 1700 according to some other embodiments of the present disclosure. The computing device 1700 includes one or more modules 1900, each of which is implemented in software. The module(s) 1900 provide the functionality of the computing device 1700 described herein. This discussion is equally applicable to the processing node 1800 of FIG. 18 where the modules 1900 may be implemented at one of the processing nodes 1800 or distributed across multiple processing nodes 1800 and/or distributed across the processing node(s) 1800 and the control system 1702.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Specific Embodiments of the Disclosure

1. A method performed by computing device, comprising:
obtaining (1606) a query from a trouble report, the query comprising text;
pre-processing (1608) the query to provide a pre-processed query;
applying (1610) the pre-processed query to a first representation-based model to provide a representation of the pre-processed query, wherein the pre-processing (1608) of the query is such that the query is formatted in a way that is acceptable to the first representation-based model;
computing (1612) similarity metrics between the representation of the pre-processed query and a plurality of representations of a plurality of pre-processed answers of a plurality of existing, previously processed, trouble reports;
creating (1614) an initial list of candidate answers based on the similarity metrics, the initial list of candidate answers comprising a plurality of candidate answers selected from among a plurality of answers of the plurality of existing trouble reports based on the similarity metrics.
   2. The method of embodiment 1 wherein the first representation-based model is a model that is able to create a semantic representation of a sentence that captures its meaning in a dense vector.
   3. The method of embodiment 1 wherein the first representation-based model is model that uses an attention mechanism for understanding and encoding sentences as a whole.
   4. The method of any of embodiments 1 to 3 wherein the first representation-based model is a bi-directional model (i.e., considers words left-to-right and right-to-left) that looks at all words in a sentence to encode the sentence.
   5. The method of embodiment 1 wherein the first representation-based model is a first representation-based BERT model.
   6. The method of embodiment 1 wherein the first representation-based model is a first sentence-BERT model, a first EPIC model, a first RepBERT model, a first ANCE model, or a first ColBERT model.
   7. The method of embodiment 1 further comprising:
pre-processing (1601) a plurality of answers of the plurality of existing trouble reports to provide the plurality of pre-processed answers; and
applying (1602) the plurality of pre-processed answers to a second representation-based model to provide the plurality of representations of the plurality of pre-processed answers.
   8. The method of embodiment 7 wherein:
pre-processing (1601) the plurality of answers and applying (1602) the plurality of pre-processed answers to the second representation-based model are performed prior to obtaining (1606) the query; and
the method further comprises storing (1604) the plurality of representations of the plurality of pre-processed answers.
   9. The method of embodiment 7 or 8 wherein the first representation-based model and the second representation-based model are the same representation-based BERT model.
   10. The method of embodiment 7 or 8 wherein the first representation-based model and the second representation-based model are the same sentence-BERT model, the same EPIC model, the same RepBERT model, the same ANCE model, or the same ColBERT model.
   11. The method of any of embodiments 1 to 10 further comprising performing (1616) a re-ranking scheme that selects a subset of the plurality of candidate answers comprised in the initial list of candidate answers to provide a ranked list of candidate answers.
   12. The method of embodiment 11 wherein performing (1616) the re-ranking scheme comprises applying (1616A) the pre-processed query and the initial list of candidate answers to a BERT-based re-ranker model to provide the ranked list of candidate answers.
   13. The method of embodiment 12 wherein the BERT-based re-ranker model is a monoBERT model, a duoBERT model, or a CEDR model.
   14. The method of embodiment 12 wherein the BERT-based re-ranker model comprises an ensemble of BERT-based models.
   15. The method of any of embodiments 11 to 14 further comprises determining (1618) whether the trouble report is a duplicate trouble report based on the ranked list of candidate answers.
   16. The method of any of embodiments 1 to 15 wherein pre-processing (1608) the query comprises:
(a) tokening text comprised in the query,
(b) detecting abbreviations in the text comprised in the query and replacing the detected abbreviations with complete words,
(c) removing numerical data,
(d) handling one or more special tokens, or
(e) a combination of any two or more of (a)-(d).
   17. The method of any of embodiments 1 to 16 wherein the query comprises text from an observation of the trouble report.
   18. The method of embodiment 17 wherein the query further comprises text from a header of the trouble report.
   19. The method of any of embodiments 1 to 18 wherein obtaining (1606) the query comprises determining (1606A) a faulty area based on information about a product involved in the trouble report and including (1606A) the faulty area within the query.
   20. The method of any of embodiments 1 to 19 wherein the similarity metrics are cosine similarity metrics, inner product metrics, or Euclidean distance metrics.
   21. A computing device adapted to perform the method of any of embodiments 1 to 20.
   22. A computing device comprising processing circuitry configured to cause the computing device to perform the method of any of embodiments 1 to 20.

### REFERENCE LIST

[1] W. E. Wong, R. Gao, Y. Li, R. Abreu, and F. Wotawa, “A survey on software fault localization,” IEEE Transactions on Software Engineering, vol. 42(8), pp. 707-740., 2016.
[2] L. Jonsson, “Machine Learning-Based Bug Handling in Large-Scale Software Development,” Linköping University Electronic Press, Linköping, 2018.
[3] J. Devlin, K. Lee, M. W. Chang, and K. Toutanova, “Bert: Pre-training of deep bidirectional transformers for language understanding,” arXiv preprint arXiv:1810.04805., 2018.
[4] B. M. Craswell, “An Introduction to Neural Information Retrieval,” Foundations and Trends® in Information Retrieval, vol. 13, pp. pp. 1-126, 2018.
[5] J. Lin, R. Nogueira and A. Yates, “Pretrained transformers for text ranking: Bert and beyond,” arXiv preprint arXiv:2010.06467, 2020.
[6] A. e. a. Radford, “Language models are unsupervised multitask learners,” OpenAI blog 1.8, 2019.
[7] Z. D. Z. Y. Y. C. J. S. R. &. L. Q. V. Yang, “XInet: Generalized autoregressive pretraining for language understanding,” arXiv preprint arXiv:1906.08237, 2019.
[8] N. Ferland, W. Sun, X. Fan, L. Yu, and J. Yang, “Automatically Resolve Trouble Tickets with Hybrid NLP,” 2020 IEEE Symposium Series on Computational Intelligence (SSCI), pp. pp. 1334-1340, 2020.
[9] Y. a. C. I.-C. a. L. H. Wang, “Generalized ensemble model for document ranking in information retrieval,” Computer Science and Information Systems, vol. 14, p. 123-151, 2017.
[10] N. Reimers and I. Gurevych, “Sentence-bert: Sentence embeddings using siamese bert-networks.,” rXiv preprint arXiv:1908.10084, 2019.
[11] R. Y. W. C. K. L. J. Nogueira, “Multi-stage document ranking with BERT,” arXiv preprint arXiv:1910.14424, 2019.
[12] “Language Processing Pipelines,” Spacy, 2021. [Online]. Available: https://spacy.io/usage/processing-pipelines. [Accessed 4 May 2021].
[13] V. Sanh, L. Debut, J. Chaumond and T. Wolf, “DistilBERT, a distilled version of BERT: smaller, faster, cheaper and lighter,” arXiv preprint arXiv:1910.01108, 2019.
[14] K. L. M. T. L. Q. V. M. C. D. Clark, “Electra: Pre-training text encoders as discriminators rather than generators,” arXiv preprint arXiv:2003.10555, 2020.
[15] X. e. a. Jiao, “Tinybert: Distilling bert for natural language understanding,” arXiv preprint arXiv:1909.10351, 2019.
[16] T. R. M. S. X. G. J. T. S. M. R. &. D. L. Nguyen, “MS MARCO: A human generated machine reading comprehension dataset,” In CoCo@ NIPS, 2016.
[17] T. W. a. L. D. a. V. S. a. J. C. a. C. D. a. A. M. a. P. C. a. T. R. a. R. L. a. M. F. a. J. D. a. S. S. a. P. v. P. a. C. M. a. Y. Jer, “Transformers: State-of-the-Art Natural Language Processing,” Proceedings of the 2020 Conference on Empirical Methods in Natural Language Processing: System Demonstrations, pp. 38-45, 2020.
[18] M. e. a. Henderson, “Efficient natural language response suggestion for smart reply,” arXiv preprint arXiv:1705.00652, 2017.
[19] S. &. Z. H. Robertson, “The probabilistic relevance framework: BM25 and beyond,” Now Publishers Inc., 2009.
[20] S. MacAvaney, et al, “Expansion via Prediction of Importance with Contextualization,” arXiv:2004.14245v2, 2020.
[21] J. Zhan et al., “REPPERT: Contextualized Text Embeddings for First-Stage Retrieval,” arXiv: 2006.15498v2, 2020.
[22] L. Xiong et al., “Approximate Nearest Neighbor Negative Contrastive Learning for Dense Text Retrieval,” arXiv:2007.00808v2, 2020.
[23] O. Khattab and M. Zaharia, “ColBERT: Efficient and Effective Passage Search via Contextualized Late Interaction over BERT,” arXiv:2004.12832v2, 2020.
[24] Y. Liu et al., “ROBERTa: A Robustly Optimized BERT Pretraining Approach,” arXiv:1907.11692v1, 2019.
[25] V. Sanh et al., “DistilBERT, a distilled version of BERT: smaller, faster, cheaper and lighter,” arXiv:1910.01108v4, 2020.
[26] K. Clark et al., “ELECTRA: Pre-Training Text Encoders as Discriminators Rather than Generators,” ICLR 2020.
[27] Z. Yang et al., “XLNet: Generalized Autoregressive Pretraining for Language Understanding,” arXiv:1906.08237v2, 2020.
[28] R. Pradeep et al., “The Expando-Mono-Duo Design Pattern for Text Ranking with Pretrained Sequence-to-Sequence Models,” arXiv:2101.05667v1, 2021.
[29] MacAvaney, Sean, et al. “CEDR: Contextualized embeddings for document ranking.” Proceedings of the 42nd International ACM SIGIR Conference on Research and Development in Information Retrieval. 2019.
[30] Nogueira, Rodrigo, Zhiying Jiang, and Jimmy Lin. “Document ranking with a pretrained sequence-to-sequence model.” arXiv preprint arXiv:2003.06713 (2020).

1. A method performed by a computing device, comprising:
obtaining a query from a trouble report, the query comprising text;
pre-processing the query to provide a pre-processed query;
applying the pre-processed query to a first representation-based model to provide a representation of the pre-processed query, wherein the pre-processing of the query is such that the query is formatted in a way that is acceptable to the first representation-based model;
computing similarity metrics between the representation of the pre-processed query and a plurality of representations of a plurality of pre-processed answers of a plurality of existing, previously processed, trouble reports; and
creating an initial list of candidate answers based on the similarity metrics, the initial list of candidate answers comprising a plurality of candidate answers selected from among a plurality of answers of the plurality of existing trouble reports based on the similarity metrics.

2. The method of claim 1 wherein the first representation-based model is a model that is able to create a semantic representation of a sentence that captures its meaning in a dense vector.

3. The method of claim 1 wherein the first representation-based model is model that uses an attention mechanism for understanding and encoding sentences as a whole.

4. The method of claim 1 wherein the first representation-based model is a bi-directional model that looks at all words in a sentence to encode the sentence.

5. The method of claim 1 wherein the first representation-based model is a first representation-based Bidirectional Encoder Representation from Transformer, BERT, model.

6. The method of claim 1 wherein the first representation-based model is a first sentence-Bidirectional Encoder Representation from Transformer, BERT, model; a first Expansion via Prediction of Importance with Contextualization, EPIC, model; a first Representation-focused BERT, RepBERT, model; a first Approximate nearest neighbor Negative Contrastive Learning, ANCE, model, or a first Contextualized Late interaction over BERT, ColBERT, model.

7. The method of claim 1 further comprising:
pre-processing a plurality of answers of the plurality of existing trouble reports to provide the plurality of pre-processed answers; and
applying the plurality of pre-processed answers to a second representation-based model to provide the plurality of representations of the plurality of pre-processed answers.

8. The method of claim 7 wherein:
pre-processing the plurality of answers and applying the plurality of pre-processed answers to the second representation-based model are performed prior to obtaining the query; and
the method further comprises storing the plurality of representations of the plurality of pre-processed answers.

9. The method of claim 7 wherein the first representation-based model and the second representation-based model are the same representation-based BERT model.

10. The method of claim 7 wherein the first representation-based model and the second representation-based model are the same sentence-BERT model, the same EPIC model, the same RepBERT model, the same ANCE model, or the same ColBERT model.

11. The method of claim 1 further comprising performing a re-ranking scheme that selects a subset of the plurality of candidate answers comprised in the initial list of candidate answers to provide a ranked list of candidate answers.

12. The method of claim 11 wherein performing the re-ranking scheme comprises applying the pre-processed query and the initial list of candidate answers to a BERT-based re-ranker model to provide the ranked list of candidate answers.

13. The method of claim 12 wherein the BERT-based re-ranker model is a monoBERT model, a duoBERT model, or a Contextualized Embeddings for Document Ranking, CEDR, model.

14. The method of claim 12 wherein the BERT-based re-ranker model comprises an ensemble of BERT-based models.

15. The method of claim 11 further comprises determining whether the trouble report is a duplicate trouble report based on the ranked list of candidate answers.

16. The method of claim 1 wherein pre-processing the query comprises:
(a) tokening text comprised in the query,
(b) detecting abbreviations in the text comprised in the query and replacing the detected abbreviations with complete words,
(c) removing numerical data,
(d) handling one or more special tokens, or
(e) a combination of any two or more of (a)-(d).

17. The method of claim 1 wherein the query comprises text from an observation of the trouble report or text from a header of the trouble report.

18. (canceled)

19. The method of claim 1 wherein obtaining the query comprises determining a faulty area based on information about a product involved in the trouble report and including the faulty area within the query.

20. The method of claim 1 wherein the similarity metrics are cosine similarity metrics, inner product metrics, or Euclidean distance metrics.

21. (canceled)

22. (canceled)

23. A computing device comprising processing circuitry configured to cause the computing device to:
obtain a query from a trouble report, the query comprising text;
pre-process the query to provide a pre-processed query;
apply the pre-processed query to a first representation-based model to provide a representation of the pre-processed query, wherein the pre-processing of the query is such that the query is formatted in a way that is acceptable to the first representation-based model;
compute similarity metrics between the representation of the pre-processed query and a plurality of representations of a plurality of pre-processed answers of a plurality of existing, previously processed, trouble reports; and
create an initial list of candidate answers based on the similarity metrics, the initial list of candidate answers comprising a plurality of candidate answers selected from among a plurality of answers of the plurality of existing trouble reports based on the similarity metrics.

24. (canceled)
